(19) United States
(12) Patent Application Publication
(10) Pub. No.: US 2007/0114003 A1
(43) Pub. Date: May 24, 2007

(54) Modular heating system for large vehicles

(75) Inventors: Peter Hesoun, Linkoping (SE); Tomas Karlsson, Aby (SE)

Correspondence Address: VENABLE LLP, P.O. BOX 34385, WASHINGTON, DC, 20043-9998, US

(73) Assignee: UWE VERKEN AB, NORRKOPING (SE)

(21) Appl. No.: 10/581,318

(22) PCT Filed: Dec. 2, 2004
(86) PCT No.: PCT/SE04/01784

§ 371 Date: Jun. 2, 2006

Related U.S. Application Data
(60) Provisional application No. 60/526,290, filed on Dec. 3, 2003.

(30) Foreign Application Priority Data
Dec. 3, 2003 (SE) 0303258-8

(51) Int. Cl. B60H 1/00

(52) U.S. Cl. 165/41; 165/146; 165/122; 165/903

(57) ABSTRACT

A modular heating system for large vehicles. At least one elongated heating element module is suitable for horizontal mounting along an interior wall and near the floor of the vehicle. The heating element module includes a convector including at least one essentially longitudinally extending pipe arranged to conduct a heating medium. The pipe is provided with a plurality of mutually spaced fins transversely mounted thereto. The system further includes at least one blower module including at least one fan. The blower module is selectively attachable to the heating element module at an arbitrary position along the extension thereof adjacent to the fins and further arranged to be selectively operable to produce a forced airflow through the plurality of fins in a direction from a side of the convector intended to be mounted facing upwards towards a side thereof intended to be mounted facing downwards.

### TECHNICAL FIELD

The present patent application relates to a modular heating system for large vehicles in accordance with the preamble of claim 1.

### BACKGROUND OF THE INVENTION

With known heating elements, e.g. when used in buses, it is usual to arrange convectors along the side walls near the floor. The use of convectors results in a warm air stream towards the ceiling, which passes over the side walls and windows of the bus. This usually results in a colder air stream over the floor from the center of the bus towards the side walls. As a consequence thereof, temperatures will tend to be higher near the ceiling than near the floor. This uneven temperature distribution and the colder air stream over the floor can be perceived as uncomfortable by the passengers of the bus. The convector is usually provided with a cover plate which is adapted to be essentially cold, in order to eliminate the risk of burning the passengers.

The problem of achieving sufficient capacity and rendering the passengers a comfortable climate in the bus with compact units using either of these known solutions is worsened still by the fact that there is a tendency today towards lower coolant temperatures in the new generations of engines for this kind of vehicles. Therefore there is a need for compact heating elements, which render an even temperature distribution and with sufficient heating capacity at these lower coolant temperatures.

A heating arrangement partially addressing the above problems is previously known through DE 199 00 600, which relates to a heating arrangement with heat transfer elements extending along the wall of a vehicle, which heat transfer elements comprises pipes allowing for a through flow of a heat conducting medium. A blowing unit is arranged to produce an airflow onto the heat transfer elements. An air duct connected to the blowing unit extends below the heat transfer elements, which air duct is extends along the floor of the vehicle adjacent to the wall thereof. The air duct further has a slit opening for expelling air up through the heat transfer elements.

A disadvantage with the arrangement known from the prior art mentioned above is that it further increases the warm air stream towards the ceiling and the colder air stream over the floor from the center of the bus towards the side walls, thus increasing the uneven temperature distribution inside the vehicle. A further disadvantage is that the blower unit required to supply a sufficiently large airflow to the air duct in case of a large vehicle will require a large size fan, with an associated high power consumption and high noise level. A yet further disadvantage is that the distribution of the airflow exiting the duct will tend to be uneven and decreasing with the distance from the blowing unit.

### SUMMARY OF THE INVENTION

One object of the invention is to provide an improved modular heating system for large vehicles, comprising at least one elongated heating element module suitable for horizontal mounting along an interior wall and near the floor of said vehicle, said heating element module comprising a convector consisting of at least one essentially longitudinally extending pipe arranged to conduct a heating medium, said at least one pipe being provided with a plurality of mutually spaced fins transversely mounted on said at least one pipe.

This object is achieved in accordance with the characterizing portion of claim 1.

Thanks to the provision of at least one blower module comprising at least one fan, which blower module is selectively attachable to said heating element module at an arbitrary position along the extension thereof adjacent to said fins and arranged to be selectively operable to produce a forced airflow through said plurality of fins in a direction from a side of said convector intended to be mounted facing upwards towards a side of said convector intended to be mounted facing downwards, which forced airflow counters any warm air stream towards the ceiling and resulting colder air stream over the floor from the center of the bus towards the side walls caused by unforced convection, rendering a more even temperature distribution within the vehicle. The modularity also providing an ability to provide increased heating efficiency at arbitrarily selected positions within the vehicle, whilst maintaining conventional unforced convection heating at other positions.

Preferred embodiments are listed in the dependent claims.

### DESCRIPTION OF DRAWINGS

In the following, the invention will be described in greater detail with reference to attached drawings, in which

FIG. 1 illustrates schematically a modular heating system in accordance with a first embodiment of the present invention.

FIG. 2 illustrates schematically a modular heating system with a heating element module comprising two pipes in accordance with a second embodiment of the present invention.

FIG. 3 illustrates schematically a modular heating system with a heating element module comprising first and second pipes which are interconnected through a pre-bent pipe section at the end of the second pipe.

FIG. 4 illustrates schematically the air flows through different sections of the modular heating system.

FIG. 5 illustrates schematically a convector of the heating element module having sections with differently spaced fins.

FIG. 6 illustrates schematically how the modular heating system in accordance with the present invention facilitates the arrangement of a continuous heating system along the wall of a vehicle, bypassing any obstacles close to the floor.

Still other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### DESCRIPTION OF EMBODIMENTS

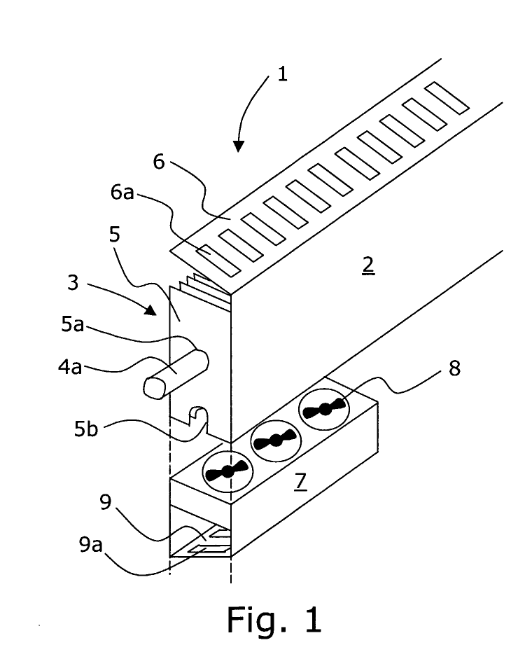

In FIG. 1, 1 denotes a modular heating system for large vehicles. The modular heating system 1 comprising at least one elongated heating element module 2 suitable for horizontal mounting along an interior wall, at the base of the wall near the floor of the vehicle. The heating element module 2 comprises a convector 3 consisting of at least one essentially longitudinally extending pipe 4a arranged to conduct a heating medium, usually water, e.g. the coolant of the vehicle engine. The pipe 4a is provided with a plurality of mutually spaced fins 5 transversely mounted thereupon. These fins 5 are arranged to increase the surface adapted for heat transfer by convection. The heating element module 2 has an essentially constant cross-section parallel to the floor and its height exceeds its thickness and the width thereof has the largest dimension, often the full length of the vehicle floor. The heating element module 2 further includes a first casing element 6 with openings 6a therein allowing for a flow of air through the heating element 2 over the fins 5 of the convector 3. When attached, the first casing element 6 at least partially covers the pipes 4a and fins 5 of the convector 3.

The modular heating system 1 further comprises at least one blower module 7 comprising at least one fan 8. The blower module 7 is selectively attachable to the heating element module 2 at an arbitrary position along the extension thereof adjacent to the fins 5. Further, the blower module 7 is arranged to be selectively operable to produce a forced airflow through the plurality of fins 5 in a direction from a side of the convector 3 intended to be mounted facing upwards towards a side of the convector 3 intended to be mounted facing downwards. The blower module 7 is preferably adapted for attachment to the heating element module 2 at a side of the convector 3 intended to be mounted facing downwards, and arranged to draw the airflow through the convector 3. However, it is also possible to arrange the blower module 7 at the side of the convector 3 intended to be mounted facing upwards, and arranged to push the airflow through the convector 3.

The fan 8 can be either of a tangential fan, in order to cover a larger extension of the heating element module, or an axial fan, enabling a minimized height of the blower module 7. It is preferred that the blower module 7 comprises a plurality of fans 8, in order to provide for producing a forced airflow through large proportion of the heating element module 2.

The blower module 7 is at lest partially covered by a second casing element 9 having a plurality of ventilation openings 9a at a side thereof intended to be mounted facing downwards. When mounted, the first and second casing elements 6, 9 are arranged to provide a continuous enclosure of the heating element module 2 and the blower module 7 together with the wall of the vehicle, in order to eliminate any risk of burning any occupants of the vehicle and render the heating system tamper proof.

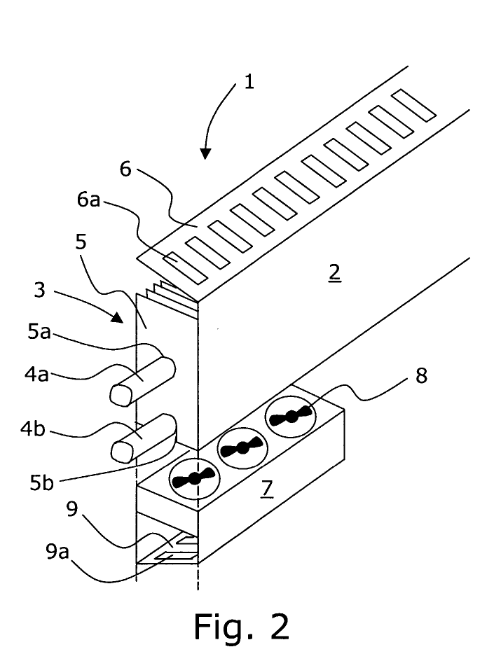

In a second embodiment, as illustrated in FIG. 2, the heating element module 2 comprises a first pipe 4a, onto which the plurality of fins 5 are arranged. The first pipe 4a passes through a hole 5a provided in the fins 5. A second pipe 4b is inserted into a cut out section 5b at an edge of the fins 5 intended to be mounted facing downwards. Hereby a flexible way of increasing the heating efficiency of the heating element module 2 is provided, e.g. through doubling the flow of heating medium. The second pipe 4b can e.g. be retrofitted to a vehicle comprising a modular heating system 1 in accordance with the present invention, if established that an increased heating efficiency is required at a later stage.

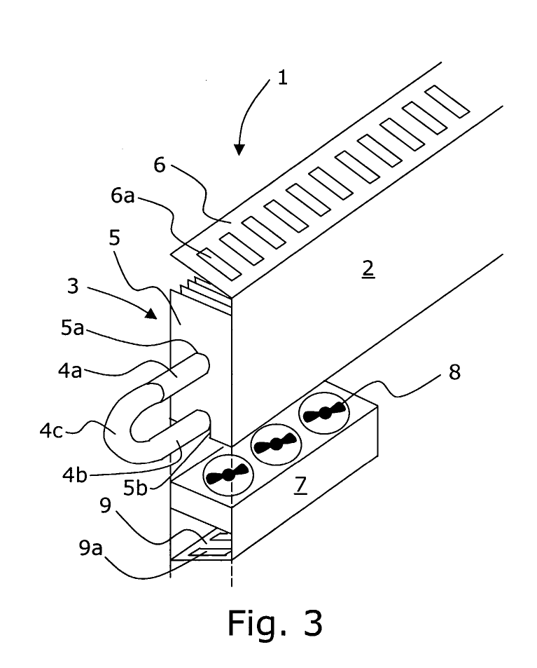

As illustrated in FIG. 3, the second pipe 4b can alternatively be provided with a pre-bent end section 4c at one end of the convector 3, which pre-bent end section 4c provides a fluid connection to the first pipe 4a. Hereby a return conduit for the flow of heating medium can be provided to the heating element module 2 for re-circulating the flow of heating medium through the convector 3 for increasing the heating efficiency thereof. Installation of a second pipe 4b is also facilitated, as only one soldering operation is required for connecting the pipes 4a, 4b, as compared to providing a separate pre-bent end section to a convector having two fixedly arranged pipes, which would require two soldering operations.

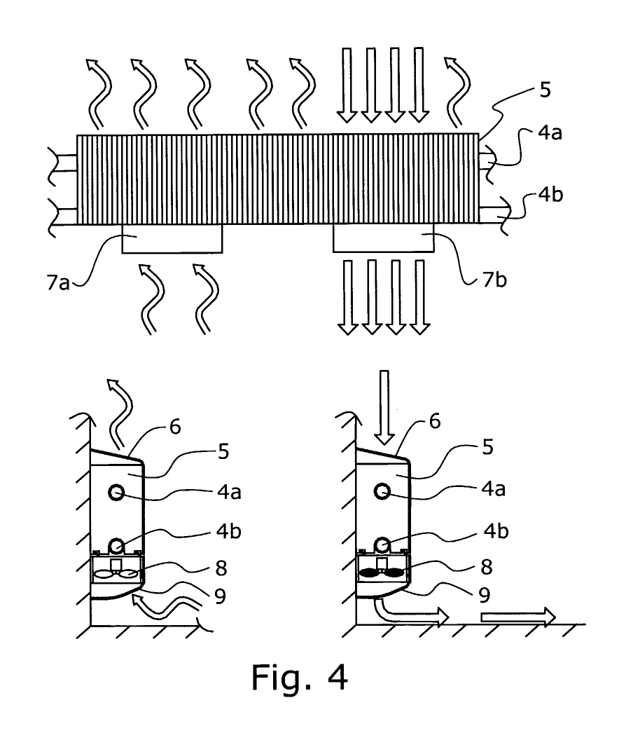

As illustrated in the top view of FIG. 4, an airflow (illustrated by the curved arrows) is allowed to pass through the left hand blower module 7a not in operation, facilitating a contribution to the heating of the vehicle through unforced convection. The portions of the heating element module 2 not provided with blower modules 7 will operate as a normal convector, contributing to the heating of the vehicle through unforced convection. The right hand blower module 7b in operation will produce a forced airflow (illustrated by the straight arrows) through the plurality of fins 5 in a direction towards the floor of the vehicle. The respective airflows are illustrated schematically by the arrows. The left hand bottom view illustrates a section through the left hand blower module 7a not in operation, and the right hand bottom view illustrates a section through the right hand blower module 7b in operation.

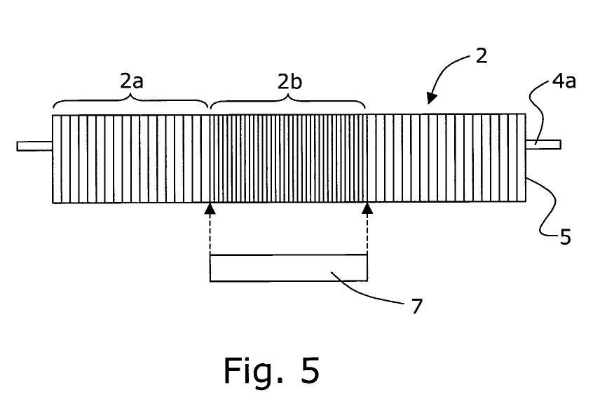

In a further embodiment, as illustrated in FIG. 5, the heating element module 2 comprises at least one first longitudinally extending section 2a having a first spacing between the fins 5 and at least one second longitudinally extending section 2b having a second, more dense, spacing between the fins 5. The blower module 7 being adapted for attachment to the heating element module 2 at the at least one second longitudinally extending section 2b. Hereby higher heating efficiency can be achieved when operating the associated blower module 7 whilst at the same time reducing the cost of the heating element module 2, through only providing the increased number of fins 5 to the sections 2b intended for attachment of blower modules 7.

In a large vehicle it is often appropriate to provide a heating system comprising a plurality of interconnected heating element modules 2, at least some of which are provided with arbitrary positioned blower modules 7 in order to provide for increased heating efficiency to selected sections of the vehicle interior, such as adjacent to door openings and similar.

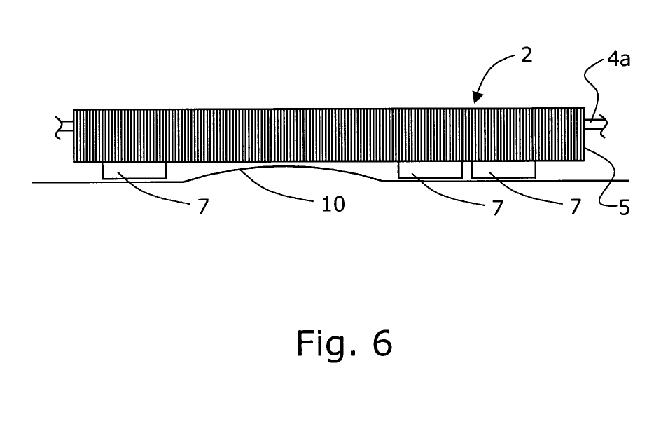

As illustrated in FIG. 6, the modular heating system 1 in accordance with the present invention also facilitates the arrangement of a continuous heating system along the wall of a vehicle, by which wall sections comprising any obstacles close to the floor, such as the illustrated wheel housing 10, can be passed while still being heated by the heating element module 2 through unforced convection, while adjacent sections without such obstacles may be provided with blower modules 7.

The modular heating system 1 according to the present invention thus provides a flexible heating system for large vehicles, such as buses, which through the modularity thereof enables for flexible scaling of the system through retrofitting to a basic system additional blower modules 7 and/or an additional heating medium conducting pipe 4b, if determined that increased heating is required for the vehicle, e.g. if a vehicle initially operated in a first climate zone is relocated for use in a second colder climate zone, or the other way around through detaching blower modules 7 and/or the additional heating medium conducting pipe 4b. The modularity of the system also facilitates adaptation to different vehicle interior configurations when installing a heating system into a vehicle for the first time.

Both the heating element modules 2 and the blower modules 7 can be produced in a number of lengths, for facilitating installation of the system to vehicles having different geometries of their internal spaces to be heated.

Through the modular heating system 1 comprising the heating element modules 2 based on convectors 3, which allows for a contribution to the heating of the vehicle through unforced convection, the additional benefit that at least a partial heating of the vehicle can be achieved through attaching the vehicle, when not in use, to a so called ramp arrangement at the bus depot, which provides for circulating a flow of heating medium through the pipes 4a, 4b of the convectors 3, can be achieved. This additional benefit is not obtainable for vehicles having heating systems based on other types of heat exchangers, which do not allow for unforced convection, such as is presently commonly used in many blower equipped vehicle heating units.

The invention is not limited to the above-described embodiments, but may be varied within the scope of the following claims.

Thus, while there have been shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. A modular heating system for large vehicles, comprising
at least one elongated heating element module suitable for horizontal mounting along an interior wall and near the floor of said vehicle, said heating element module comprising a convector comprising at least one essentially longitudinally extending pipe arranged to conduct a heating medium, said at least one pipe being provided with a plurality of mutually spaced fins transversely mounted on said at least one pipe; and
at least one blower module comprising at least one fan, which blower module is selectively attachable to said heating element module at an arbitrary position along the extension thereof adjacent to said fins and arranged to be selectively operable to produce a forced airflow through said plurality of fins in a direction from a side of said convector intended to be mounted facing upwards towards a side of said convector intended to be mounted facing downwards.

2. The modular heating system according to claim 1, wherein said at least one blower module is adapted for attachment to said heating element module at a side of said convector intended to be mounted facing downwards.

3. The modular heating system according to claim 1, wherein said heating element module comprises a first pipe onto which said plurality of fins are arranged with said first pipe passing through a hole provided in said fins and a second pipe which is inserted into a cut out section at an edge of said fins intended to be mounted facing downwards.

4. The modular heating system according to claim 1, wherein said heating element module comprises at least one first longitudinally extending section having a first spacing between said fins and at least one second longitudinally extending section having a second spacing between said fins, and wherein said at least one blower module is adapted for attachment to said heating element module at said at least one second longitudinally extending section.

5. The modular heating system according to claim 1, wherein said at least one fan is a tangential fan.

6. The modular heating system according to claim 1, wherein said at least one fan is an axial fan.

7. The modular heating system according to claim 1, wherein said blower module comprises a plurality of said fans.

8. The modular heating system according to claim 1, further comprising:
a plurality of interconnected heating element modules at least some of which are provided with arbitrary positioned blower modules.

9. The modular heating system according to claim 3, wherein said second pipe is provided with a pre-bent end section at one end of said convector, which pre-bent end section provides a fluid connection to said first pipe.

10. The modular heating system according to claim 2, wherein said convector is at lest partially covered by a first casing element having a plurality of ventilation openings at a side thereof intended to be mounted facing upwards, and wherein said blower module is at least partially covered by a second casing element having a plurality of ventilation openings at a side thereof intended to be mounted facing downwards, said first and said second casing elements when mounted providing a continuous enclosure of said heating element module and said blower module together with said wall.
